(19) United States
(12) Patent Application Publication
(10) Pub. No.: US 2026/0101310 A1
(43) Pub. Date: Apr. 9, 2026

(54) CARRIER AGGREGATION POSITIONING

(71) Applicant: Nokia Technologies Oy, Espoo (FI)

(72) Inventors: Oana-Elena BARBU, Aalborg (DK); Ryan KEATING, Chicago, IL (US); Hyun-Su CHA, Chicago, IL (US)

(21) Appl. No.: 19/115,677

(22) PCT Filed: Sep. 27, 2022
(86) PCT No.: PCT/EP2022/076796

§ 371 Date: Mar. 26, 2025

(51) Int. Cl. H04W 64/00

(52) U.S. Cl. CPC H04W 64/00

(57) ABSTRACT

Inter-alia, a method is disclosed comprising: obtaining a request for measuring at least a combined carrier aggregation error, CAE of one or more component carriers, CCs, configured for the apparatus in a mobile communication network, wherein the combined CAE is indicative of a total of one or more errors resulting from at least one of a transmit error, receive error, or a processing of the one or more CCs; obtaining, based on the request, at least one of one or more positioning reference signals, PRSs, or one or more sounding reference signals, SRSs, of the one or more CCs; determining, based, at least in part, on at least one of the obtained one or more PRSs, or the one or more SRSs, the combined CAE; and providing the determined combined CAE. It is further disclosed an according apparatus, computer program and system.

### FIELD

The following disclosure relates to the field of mobile communication networks, or more particularly relates to systems, apparatuses, and methods for error mitigation in carrier aggregation positioning.

### BACKGROUND

In mobile communication networks, positioning is enabled and provides a certain accuracy. The accuracy requirements increase with the evolving of the mobile communication networks, e.g. in the order of tens of centimeters for commercial uses cases, and up to an order of magnitude lower for Industrial Internet of Things (IIoT) applications. To reach such stringent requirements, it is beneficial to mitigate errors that may occur due to a measurement based on which the positioning is performed.

### SUMMARY OF SOME EXEMPLARY EMBODIMENTS

The positioning accuracy enhancement in 5G New Radio (NR) e.g. by mitigating UE receive (Rx)/transmit (Tx) and gNB Rx/Tx timing delays has been considered through Timing Error Group (TEG) standardization. Such timing group errors/delays can be thought of as uncompensated delay occurring from processing of signals from the baseband to the antenna of a respective device (e.g. user device).

This approach may not sufficiently remove timing errors, but only give an indication of how accurate an estimation of a position can be expected to be. In other words, a respective framework as defined by TEG provides procedures through which errors ranges are identified. It would however be beneficial if the framework would further enable e.g. for a cancelling the Tx/Rx errors associated with a positioning signal transmission and/or reception.

For convenience, a list of abbreviations used in the following is already given at this point:
3GPP 3rd Generation Partnership Project
5G Fifth generation
6G Sixth generation
CA Carrier Aggregation
CAE Carrier Aggregation Error
CC Component Carrier
DL Downlink
gNB Next Generation Node B
LMF Location Management Function
LPP LTE Positioning Protocol
LoS Line-of-Sight
LTE Long Term Evolution
MAC Medium Access Control (Layer)
NLOS Non-Line-of-Sight
NR New Radio
NRPPa NR Positioning Protocol A
PRS Positioning Reference Signal
PM Positioning Measurement
RAN Radio Access Network
RF Radio Frequency
RSRP Reference Signal Received Power
RSRPP RSRP per path
RSRQ Reference Signal Received Quality
RSTD Received Signal Time Difference
SRS Sounding Reference Signal
TE Timing Error
TEG Timing Error Group
ToA Time of Arrival
TDoA Time Difference of Arrival
TRP Transmission Reception Point (also referred to transmit receive point)
UE User Equipment (also referred to as user device)
UL Uplink

According to a first exemplary aspect, a method is disclosed, the method comprising:
obtaining a request for measuring at least a combined carrier aggregation error, CAE of one or more component carriers, CCs, configured for the apparatus in a mobile communication network, wherein the combined CAE is indicative of total combined CAE resulting from at least one of a transmit error, receive error, or a processing of the one or more CCs;
obtaining, based on the request, at least one of one or more positioning reference signals, PRSs, or one or more sounding reference signals, SRSs, of the one or more CCs;
determining, based, at least in part, on at least one of the obtained one or more PRSs, or the one or more SRSs, the combined CAE; and
providing the determined combined CAE.

This method may for instance be performed and/or controlled by an apparatus, for instance a user device, user equipment, mobile terminal or a TRP. Alternatively, the method may for instance be performed and/or controlled by a user device, user equipment or mobile terminal. For instance, the method may be performed and/or controlled by using at least one processor of the user device, user equipment, mobile terminal or TRP.

Such a user device (e.g. represented by a respective apparatus according to the first exemplary aspect as disclosed above) will also be referred to as the apparatus according to the first exemplary aspect in the following. It may be a UE or mobile terminal of a cellular network (also referred to as mobile communication network), for instance a 3G, LTE/4G, 5G NR, 5G or 6G network. Further, it may be a mobile device, e.g. a handset, a smartphone, a tablet, a laptop, or any other mobile device. In various embodiments, it may be a vehicle for travelling in air, water, or on land, e.g. a plane or a drone, a ship or a car or a truck. It may also be a robot, a sensor device, a wearable device, an Internet of Things (IOT) device, a Machine Type Communication (MTC) device, or the likes. Herewith and in the following, the terms user device, UE, and/or mobile terminal are used for such disclosed example apparatus(es) of the first exemplary aspect. They may also be referred to as first apparatus.

A respective TRP may be provided by or hosted by a base station of a cellular network. Such a TRP may serve a respective user device as an entity enabling communication for the respective user device.

According to a second exemplary aspect, a method is disclosed, the method comprising:
sending a request for measuring at least a combined carrier aggregation error, CAE of one or more component carriers, CCs configured for a user device or a TRP in a mobile communication network, wherein the combined CAE is indicative of total combined CAE resulting from at least one of a transmit error, receive error, or a processing of the one or more CCs;
obtaining the combined CAE; and
determining a position of at least one of a user device or transmission and reception point, TRP, based, at least in part on the obtained combined CAE.

This method may for instance be performed and/or controlled by an apparatus, for instance a network node (e.g. a server, part of a server, and/or hosted by a server) or a function of a mobile communication network, e.g. a LMF. Alternatively, this method may be performed and/or controlled by more than one apparatus, for instance a server cloud comprising at least two servers of a mobile communication network. For instance, the method may be performed and/or controlled by using at least one processor of the network node, or function of a mobile communication network, e.g. the LMF.

A respective network node may for example be understood as an electronic device of the mobile communication network or a core network of a communication system, such as the mobile communication network. For example, the network node may be in communication with a base station or a user device, e.g. via a base station. Generally, a network node may be a hardware and/or software component implementing a certain functionality, such as the LMF. In an example of the exemplary aspect, the network node may be a node as defined by the 3GPP 5G (or NR) standard. Accordingly, while the network node may be understood to be implemented in or be a single device or module, the network node may also be implemented across or comprise multiple devices or modules. Multiple network nodes of the exemplary aspect may in particular establish a communication system or network, which may in particular be an NR or 5G system or any other mobile communications system defined by a past or future standards, in particular successors of the present 3GPP standards. Herewith and in the following, the term LMF is used for such disclosed example apparatuses of the second exemplary aspect. It may also be referred to as second apparatus.

According to a further exemplary aspect, a computer program is disclosed, the computer program when executed by a processor causing an apparatus, for instance a server, to perform and/or control the actions of the method according to the first and/or second exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first and/or second exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the method according to the first and/or second exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

According to a further exemplary aspect, a system is disclosed, comprising:
a first apparatus according to the first exemplary aspect as disclosed above, and a second apparatus according to the second exemplary aspect as disclosed above.

Any disclosure herein relating to any exemplary aspect is to be understood to be equally disclosed with respect to any subject-matter according to the respective exemplary aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step itself. The same holds for any passage describing at least one processor; and at least one memory including computer program code; the at least one memory and the computer program code configured to, with the at least one processor, cause an apparatus at least to perform a step.

In the following, exemplary features and exemplary embodiments of all aspects will be described in further detail.

The request for measuring at least a combined CAE of one or more (e.g. aggregated) CCs is obtained, e.g. by receiving the request (e.g. from the second apparatus). The first apparatus (e.g. user device) may for instance be configured with the one or more CCs so that the first apparatus is enabled to apply or activate the configured CCs for a communication and/or a deployment of (e.g. CA) positioning. As the first apparatus may or may not use the one or more CCs (e.g. at least one additional carrier) for a data communication, the one or more CCs may be used at least for a positioning, and additionally or alternatively, e.g. for a communication in case data communication is needed by the first apparatus.

A respective CC, as used herein, may also be referred to as a carrier or a positioning frequency layer. These mentioned expressions CC, carrier, and positioning frequency layer are interchangeable.

Such CA positioning, as used herein, refers to a positioning that is based, at least in part, on one or more CC respectively signal(s) transmitted via such one or more CCs. Such CA positioning may be based on a 5G or an NR mobile communication network (also referred to as next generation radio access network (NG-RAN)) and may utilize, among other things, time-and/or angle-based positioning methods. Such mobile communication network may comprise a location management function (LMF; e.g. second apparatus), as an entity of the respective 5G or NR positioning architecture. Such LMF may receive measurements and assistance information from e.g. the NG-RAN as a respective mobile communication network and one or more user devices (e.g. UEs; first apparatuses), e.g. via a respective access and mobility management function (AMF, another entity of the respective NG-RAN) and e.g. over a respective interface to determine (e.g. compute) a respective position of the user device. NG-RAN may utilize a next generation interface between the NG-RAN and a core network, e.g. a new NR positioning protocol A, referred to as NRPPa protocol. NRPPa protocol may thus be utilized. Via such NRPPa protocol, e.g. among other things, positioning information e.g. between NG-RAN respectively entities of the NG-RAN and the LMF may be communicated, e.g. over the so-called next generation control plane interface (NG-C). Such addition in the 5G or NR architecture may provide a framework for positioning in 5G or NR. The respective LMF may further configure the user device e.g. using the LTE positioning protocol (LPP) e.g. via a respective AMF. The NG RAN may configure the user device e.g. using radio resource control (RRC) protocol over LTE-Uu and NR-Uu interfaces, to name but a few non-limiting examples.

The one or more CCs may be aggregated, which may also be referred to as carrier aggregation. Such carrier aggregation may be used by the respective mobile communication network, e.g. to increase a bandwidth. This may allow for an increased bit rate of data communications. The one or more CCs may be aggregated in the time domain and/or in the frequency domain. The first apparatus may be allocated DL and/or UL resources on such one or more aggregated resources of the one or more CCs.

The mobile communication network may comprise multiple network devices of all exemplary aspects which may in particular establish a communication system or network, which may in particular be a NR or 5G system (5GS) or any other mobile communications system defined by a past or future standard, in particular successors of the present 3GPP standards, to name but a few non-limiting examples.

Based on the request (e.g. in response to a received request), at least one of the one or more PRSs or the one or more SRSs is obtained, e.g. by measuring at least one of the one or more PRSs or SRSs.

In addition or in the alternative, example embodiments according to all exemplary aspects may be based on any reference signal(s) which is (are) used for positioning. Thus, instead of the respective PRS respectively SRS, any other kind of reference signal usable for positioning can be used. Example embodiments, as disclosed, can be realized using such reference signal(s) in any occasion where PRS respective SRS is disclosed in this specification.

The one or more PRSs may be measured in case example embodiments of all exemplary aspects are applied to a DL scenario from the perspective of the first apparatus (e.g. user device). The one or more SRS may be measured in case example embodiments of all exemplary aspects are applied to a UL scenario from the perspective of the first apparatus (e.g. user device). The one or more PRSs may be sent by a respective TRP to the user device. The one or more SRS may sent by a respective user device to a respective TRP. The first apparatus may be enabled to measure both: one or more PRSs and one or more SRS, e.g. dependent upon the first apparatus acting in a role of UL or DL communication. It will be understood that the first apparatus may not measure simultaneously one or more PRSs and one or more SRSs based on a single request for a combined CAE.

A respective PRS (also referred to as NR PRS) in a DL communication and/or a respective SRS (also referred to as NR SRS) in a UL communication are understood herewith as signals supporting downlink-based respectively uplink-based positioning. A respective PRS may have a certain delay spread range, enabling the respective PRS to be obtainable (e.g. measurable) from potentially distant neighboring user devices or base stations (e.g. TRPs) for position determining (e.g. estimation). A respective PRS may cover the whole 5G/NR bandwidth and may be transmitted over multiple symbols that can be aggregated to accumulate power. A respective base station (e.g. TRP) can then transmit a respective PRS in different sets of subcarriers to avoid interference. For example, different TRPs can transmit PRSs with different Comb or Comb-offset.

In the UL direction, a respective SRS may be used for positioning. Since positioning may be based on one or more SRSs of certain CCs provided by a respective serving base station, wherein this base station in this case receives the respective SRSs, a respective SRS may cover the full (e.g. NR) bandwidth. Further, respective resource elements of a respective SRS may be spread across different symbols so as to cover certain (e.g. all) subcarriers. The configuration of positioning SRS of a certain CC may thus be provided by a serving base station (e.g. gNB). Multiple (e.g. at least two) SRS resources may be configured. The first apparatus (e.g. UE) may transmit a respective (e.g. each) SRS resource targeting a specific TRP.

Based, at least in part, on the obtained (e.g. measured) one or more PRSs and/or the one or more SRSs, the first apparatus determines (e.g. estimates) a combined CAE. Such a combined CAE is indicative of a total combined CAE e.g. resulting from a transmit error, receive error, and/or a processing (e.g. delay and represented by value, interval or range) of the one or more CCs. Such a combined CAE may be representative of one or more errors associated with a/the joint processing of the one or more CCs (e.g. occurring on part of the first apparatus and/or the second apparatus). From such a determined combined CAE, example embodiments of all exemplary aspects may determine (e.g. derive) how trustworthy a CA-PM and/or CA-RSTD is and/or to what extent such a PM respectively RSTD should be used when determining (e.g. estimating) the position/location of the first apparatus. The determining of the position of the first apparatus may be performed and/or controlled by the second apparatus. Based on such a combined CAE, the second apparatus may determine (e.g. process) how the one or more CCs are or have been combined e.g. by the first apparatus. The determined combined CAE may allow to mitigate one or more error(s) in positioning, in particular in CA Positioning.

The determined combined CAE is provided (e.g. sent), e.g. from the first apparatus to the second apparatus (e.g. a LMF).

The obtained (e.g. measured) PRS(s) and/or SRS(s) may be measured to determine one or more angle of arrival (AOA) measurements, one or more observed time difference of arrivals (OTDOA), DL-TDOA, uplink time difference of arrival (UL-TDOA) and/or power measurements of the respective PRS(s) and/or SRS(s). This may allow to determine the combined CAE which may enable that a position is determined based e.g. on a round trip time (RTT) and/or based on certain observable angles of the respective PRS(s) and/or SRS(s) considering the combined CAE. This may allow to mitigate errors and as a result enhance the accuracy of CA positioning.

According to an exemplary embodiment of all exemplary aspects, the combined CAE is a measure of a respective error associated with a received signal time difference, RSTD, measurement (e.g. made) over multiple (e.g. at least two) CCs of the one or more CCs.

According to an exemplary embodiment of all exemplary aspects, the combined CAE is a measure of a respective error associated with a Positioning Measurement, PM, (e.g. made) over multiple (e.g. at least two) CCs of the one or more CCs.

Herewith, the expressions ‘CAE’ and ‘combined CAE’ are used. The difference, as understood herewith between the CAE and the combined CAE is that the combined CAE may be the total error stemming from baseband processing delay, and transmit and/or receive error(s), while the CAE may be measured as an error not having the combination of errors. CAE may for instance be a measuring of a ToA measurement error for each respective CC of the one or more CCs solely so that the CAE may represent such measurements, however, e.g. without a processing delay, to name but one non-limiting example.

The combined CAE is a measure of error e.g. associated with an RSTD and/or PM measurement made over multiple CCs of the one or more CCs. Thus, the determined combined CAE may cover a timing error e.g. caused by one or more group delays from the multiple CCs. The respective RSTD and/or PM measurements may be made over multiple CCS, as provided by one or more TRPs.

For instance, a TEG may be defined at each CC of the one or more CCs, or in other words, for a respective CC of the one or more CCs. For Multi-RTT and TDOA technique(s), the first apparatus (e.g. user device) may measure such timing e.g. as TDoA measurement from a respective TRP of one or more TRPs that may provide a respective CC of the one or more CCs. For example, the first apparatus may measure TDoA (Time of Arrival) measurement(s) from two PRS resources where the PRS resources are transmitted through different CCs and a respective (e.g. each) PRS resource is associated with a specific TRP Tx TEG.

For CA, for example a PRS #1 and a PRS #2 may be transmitted on first CC #1 provided by a first TRP and on a second CC #2 may be provided by a second TRP. A timing error from CC #1 may be associated with a TEG #1 and a timing error from CC #2 may be associated with TEG #2.

For a single measurement of PRS and/or SRS e.g. based on (e.g. extracted from) CC #1 and CC #2, the first apparatus (e.g. user device) may report another TEG information, e.g. comprised by the combined CAE. In this case, the combined CAE may be determined based on a timing error from one (e.g. a respective) CC and further be based on another group delay from another CC of the one or more CCs. In this way, the obtained (e.g. measured) PRSs and/or SRS may allow to determine (e.g. measure) a RSTD or PM measurement made over multiple CCs, here CC #1 and CC #2.

According to an exemplary embodiment of all exemplary aspects, the request is indicative of at least the one or more CCs.

The request may comprise the one or more CCs for which the first apparatus may then obtain (e.g. measure) the respective PRS or SRS. The request may comprise one or more identifiers of the respective one or more CCs for which the first apparatus may then obtain the respective PRS or SRS. Additionally or alternatively, the request may be indicative of the respective CC(s) for which the first apparatus may obtain the respective PRS or SRS, e.g. by comprising or being accompanied by an information element (IE) enabling the first apparatus to determine (e.g. derive) the respective CC(s) of the one or more CCs for which the first apparatus may obtain the respective PRS or SRS. This may e.g. be done based on a look-up table or a configuration obtained (e.g. received) on part of the first apparatus enabling to identify the respective CC(s) of the one or more CCs based on the respective indications of the respective CC(s).

According to an exemplary embodiment of the first exemplary aspect, the request is further for or indicative of or comprises an indicator for a CC ranking, and the method further comprises:
determining the CC ranking indicative of a weighting of the one or more CCs, wherein the CC ranking is determined based on at least one of the obtained one or more PRSs or SRSs.

In addition or in the alternative to the weighting, the CC ranking may be indicative of whether a respective CC of the one or more CCs has an equal or different weighting than another CC of the one or more CCs, and/or the respective CC(s) of the one or more CCs, and/or if a respective CC or all CCs of the one or more CCs are discarded for the determining of the combined CAE. A respective CC of all CCs of the one or more CCs may be discarded for the determining of the combined CAE e.g. in case the obtained PRS(s) and/or SRS(s) are of low quality, the respectively obtained PRS and/or SRS value may be below a predetermined threshold value, to name but one non-limiting example. A respective discarded CC of the one or more CC may be assigned with a “0” weight/rank, for instance. A respective predetermined threshold value may be any of the standardized measurements of the 3GPP standard. For instance, a respective predetermined threshold value may be received power value (e.g. RSRP) of a respective (e.g. each) CC of the one or more CCs, a RSRPP (RSRP per path) or a LoS/NLOS indicator of a respective (e.g. each) CC of the one or more CCs, or a RSRQ value of a respective (e.g. each) CC of the one or more CCs, or a combination thereof, to name but a few non-limiting examples.

According to an exemplary embodiment of all exemplary aspects, the combined CAE is determined (e.g. further) based on the CC ranking and at least one of the transmit error or receive error of the respective CCs.

In addition or in the alternative, the combined CAE may be determined based, at least in part, on a respective weighting of the respective CC(s) of the one or more CCs for which (a) respective PRS(s) and/or SRS(s) are obtained (e.g. measured).

According to an exemplary embodiment of the second exemplary aspect, the (e.g. sent) request is further for a CC ranking, and the method further comprises:
obtaining the CC ranking (e.g. together with the combined CAE) indicative of a weighting of the one or more CCs.

The determined CC ranking may be provided by the first apparatus, e.g. to the second apparatus so that the second apparatus can obtain (e.g. receive) the CC ranking, e.g. for further usage such as a determining of a respective position of the first apparatus.

According to an exemplary embodiment of all exemplary aspects, the request is comprised by (e.g. attached to) or is accompanying LPP assistance data.

From the perspective of the second apparatus, the request is provided by the second apparatus (e.g. the LMF) to the first apparatus (e.g. the user device). Likewise, from the perspective of the first apparatus, the request is received by the first apparatus (e.g. the user device) and stems from the second apparatus (e.g. the LMF).

According to an exemplary embodiment of the first exemplary aspect, the request is further for measuring at least one of one or more positioning measurements, PMs, or one or more received signal time differences, RSTDs, and the method further comprises:
determining at least one of the one or more PMs or the one or more RSTDs based, at least in part, on a respective PM for a certain CC of the one or more CCs for which at least one of the one or more PRSs or SRSs are obtained, or on a respective RSTD of a certain CC of the one or more CCs for which at least one of the one or more PRSs or SRSs are obtained.

In addition, according to an exemplary embodiment of the first exemplary aspect, the method further comprises:
providing the determined one or more PMs, or RSTDs, or the determined one or more PMs, or RSTDs together with (e.g. accompanying) the determined combined CAE.

The combined CAE may be a measure of a total error associated with the determined RSTD and/or PM for a respective CC of the one or more CCs. Thus, the combined CAE may be determined based on the determined RSTD and/or PM e.g. made over multiple or a plurality of (e.g. at least two) CCs of the one or more CCs.

According to an exemplary embodiment of all exemplary aspects, a respective PM of the one or more PMs is represented by a timing measurement.

A respective timing measurements may be a RSTD, ToA, or Rx-Tx time difference, to name but a few non-limiting examples.

For instance, a respective PRS is transmitted (e.g. as a PRS transmission) across a plurality of carriers (e.g. CCs): c1, . . . , cN. A respective of these plurality of (e.g. one or more) CCs may be characterized by a TX TE (because of carrier dependent STO, CFO, PN): txe1, . . . , txeN; and may be associated with a different bandwidth: b1, . . . , bN.

The first apparatus may receive the signal at the plurality of CCs, and the RF chain of the first apparatus may introduce an RX TE at each CC of the plurality of CCs: rxe1, . . . , rxeN. To benefit from the CA transmission, the first apparatus may thus combine signal samples in baseband (BB) over (e.g. all) received carriers and bandwidths. To determine the combined CAE; the first apparatus may extract a single positioning metric (PM), e.g. representative of the signal spread over the enlarged bandwidth B=b1+ . . . +bN. As a result of the above disclosed process, the PM estimate may be characterized by an overall error (thus combined) CAE due to:
1) the Tx TE txe1, . . . , txeN,
2) the Rx TE rxe1, . . . , rxeN, and/or
3) how the first apparatus combines the carriers in BB (e.g. how many CCs the UE uses and/or how the CCs are weighted when estimating PM).

Thus, combined CAE may be utilizable by the second apparatus (e.g. LMF) for error mitigating in CA positioning since the combined CAE may be indicative of how trustworthy the CA-PM is and to what extent the respective CA-PM should be used when determining (e.g. estimating) the position of the first apparatus (e.g. as its target UE location). For accurate positioning, it becomes thus paramount that combined CAE is made available to the second apparatus by the first apparatus, e.g. by respectively providing at least the combined CAE.

According to an exemplary embodiment of all exemplary aspects, the combined CAE is determined, based on the weighting of a respective CC of the one or more CCs and (e.g. in addition) on the one or more PMs or RSTDs.

According to an exemplary embodiment of the first exemplary aspect, the apparatus (e.g. first apparatus) is a user device (e.g. a UE) or (e.g. represents) a transmission and reception point, TRP.

As disclosed above, the request is sent from the second apparatus to the first apparatus. In this way, the first apparatus can obtain (e.g. receive) the request for measuring at least the combined CAE of one or more CCs. Prior to sending the request, the second apparatus may determine the one or more CCs for the first apparatus. Then, the request may further be indicative of the one or more CCs for which the CAE may be measured. The request may trigger the first apparatus to determine the combined CAE.

Based on the sent request (by the second apparatus), the combined CAE is obtained, e.g. by receiving the combined CAE e.g. from the first apparatus to which the request was sent. Thus, the combined CAE may be obtained by the second apparatus in response to the sent request. The combined CAE resulting among other things from the processing delay of the first apparatus may thus represents the processing of the one or more CCs as done e.g. by the first apparatus.

Based on the obtained combined CAE, the second apparatus determines (e.g. estimates) a position of the at least one user device. The at least one user device may be the first apparatus. Further, the at least one user device may be the first apparatus to which the request was sent. In an example embodiment of all exemplary aspects, the request may not be sent (e.g. provided to) directly to the first apparatus, but to another entity (e.g. base station or user device e.g. in sidelink communication with the first apparatus) of the mobile communication that may forward the request to the first apparatus.

Further, based on the obtained combined CAE, the second apparatus determines (e.g. estimates) a position of the at least one TRP. In this case, the request may have been sent to the respective TRP.

According to an exemplary embodiment of the second exemplary aspect, the method further comprises:
providing a positioning request (e.g. to a TRP) comprising at least one of a transmit, Tx, (e.g. and/r receive, Rx,) timing error per CC of the one or more CCs, or a Tx CAE (e.g. and/or a Rx CAE).

Upon obtaining (e.g. reception) of the combined CAE, the second apparatus may assess how the one or more CCs may have been combined (e.g. by the first apparatus). Then, the second apparatus may request from a respective TRP (or a plurality of TRPs providing the one or more CCs e.g. to the first apparatus) a TX CAE, i.e. the combined TX timing error, where the combination is done for the CC which were used e.g. by the first apparatus.

According to an exemplary embodiment of the second exemplary aspect, the method further comprises: obtaining (e.g. receiving based on (e.g. in response to) the positioning request) a positioning report indicative of at least one of the Tx (and/or Rx-) timing error per CC of the one or more CCs or the Tx CAE (and/or the Rx CAE).

Thus, e.g. based on the positioning request that may have been sent to a respective TRP, the second apparatus may obtain (e.g. receive) the report which may comprise the request information.

When a respective TRP provides (e.g. reports) the respective combined CAE and/or CC ranking (e.g. as a positioning report), e.g. comprising a combined Tx CAE, there may be two different options:
In option 1, the respective TRP may (e.g. simply) report the Tx TEG of (e.g. each) the one or more individual CCs of the one or more CCs and the second apparatus (e.g. LMF) may assume the overall Tx CAE margin is a summation of the individual Tx TEG margins (i.e., CC #1 Tx TEG margin+CC #2 Tx TEG margin).
In option 2, the respective TRP may report a combined Tx CAE (e.g. directly) which may take into account or represent any optimizations the respective TRP can do or has characterized e.g. based on a CA transmission (e.g., if the respective CC(s) of the one or more CCs share some components, the overall CAE margin of such a combined Tx CAE may be strictly smaller than the combined TEG margins)).

For option1 and/or option 2, as an example, the TRP (e.g. represented by the first apparatus) may inform the LMF (e.g. represented by the second apparatus) that a specific Tx TEG ID is associated with multiple CCs. Then, the LMF may use the overall Tx CAE margin if the LMF receives specific positioning measurements measured from (e.g. based on) the multiple CCs (of which the LMF was informed via the specific Tx TEG ID, for instance).

For instance, a respective first TRP1 and a respective second TRP2 may report a Tx CAE1 and a Tx CAE2. Additionally or alternatively, the respective TRP1 and TRP2 may report the components/measurements necessary for the second apparatus (e.g. LMF) to determine (e.g. calculate) Tx CAE1 and Tx CAE2. Next, the second apparatus (e.g. LMF) may store the respective report(s) (e.g. comprising or representing RSTD, CAE, Tx CAE1, Tx CA2, or a combination thereof). The second apparatus (e.g. LMF) may be able to consider the respective report(s) for further differential operation e.g. between RSTD measurements tagged with the same Tx/Rx CAE information.

According to an exemplary embodiment of the second exemplary aspect, the method further comprises:
providing (e.g. based on LPP) at least one of the Tx (e.g. and/or Rx) timing error or the Tx CAE (and/or Rx CAE) to at least one of a user device or a TRP.

The second apparatus (e.g. LMF) may provide the first apparatus (e.g. user device) with these information e.g. for a so-called UE-based positioning which may be performed and/or controlled by the user device.

Also, the second apparatus may provide the first apparatus (if the first apparatus represents a respective TRP) the information e.g. obtained (e.g. received) as such a positioning report.

According to an exemplary embodiment of the second exemplary aspect, the request is further for measuring at least one of one or more positioning measurements, PMs, or one or more received signal time differences, RSTDs, and the method further comprises:
obtaining at least one of the one or more PMs or the one or more RSTDs.

Based on the request (e.g. in response to the request) for measuring the combined CAE that may have been sent to the first apparatus, and in case the request is further for measuring at least one of PMs or RSTD, the recipient of the request (e.g. the first apparatus) may be triggered to perform and/or control the respective obtaining (e.g. measuring) of the respective one or more PMs or RSTDs. Then, the requested measured PMs and/or RSTDs may be obtained by the second apparatus, e.g. by receiving the measured PMs and/or RSTDs, e.g. from the first apparatus.

According to an exemplary embodiment of the second exemplary aspect, the method further comprises:
determining one or more parameters for one or more LPP sessions served by the apparatus based, at least in part, on the obtained CC ranking.

For instance, the second apparatus may optionally attach the one or more parameters obtained (e.g. received) based on the sent request for measuring the combined CAE (e.g. the TX error margins as e.g. comprised by the combined CAE) to LPP assistance data (e.g. as a new IE). This may allow to enhance positioning accuracy. As an example, e.g. via such a new IE, e.g. in a LPP measurement report, the first apparatus (e.g. user device) may transfer the respective CAE and optionally the CC ranking, if available. The first apparatus may e.g. provide (e.g. report) the combined CAE and optionally the CC ranking (if available) independent with the measurements.

The second apparatus (e.g. LMF) that may obtain the combined CAE and determines (e.g. estimates or computes) the position of the first apparatus, may subsequently use such a combined CAE and the CC ranking to optimize e.g. the design of a future LPP session for the same first apparatus, or for a nearby neighbor device, to name but a few non-limiting examples.

According to an exemplary embodiment of the second exemplary aspect, the second apparatus is or is part of a location management function, LMF, (e.g. of a base station).

The features and example embodiments described above may equally pertain to the different aspects.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

### In the Figures Show:

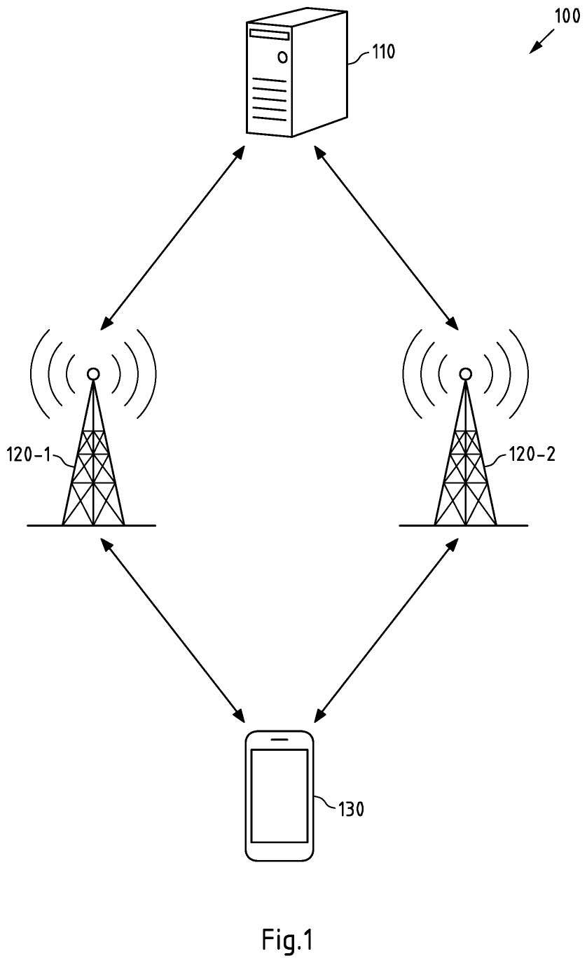

FIG. 1 a schematic block diagram of a system according to an exemplary aspect;

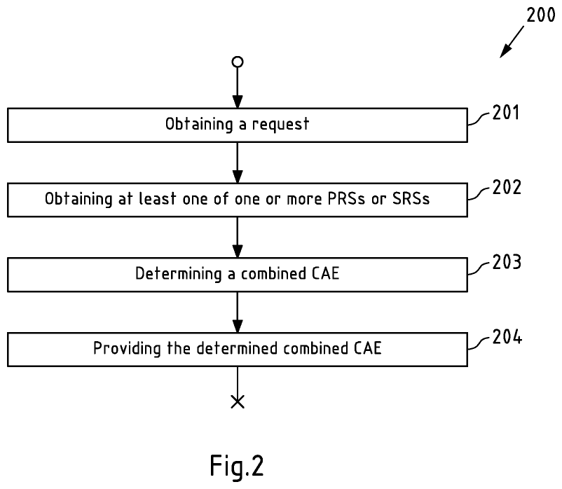

FIG. 2 a flowchart showing an example embodiment of a method according to the first exemplary aspect;

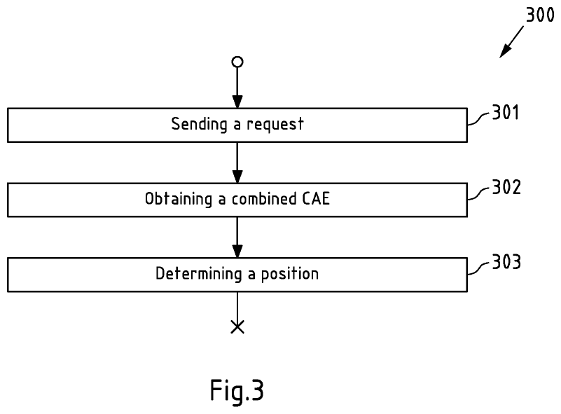

FIG. 3 a flowchart showing an example embodiment of a method according to the second exemplary aspect;

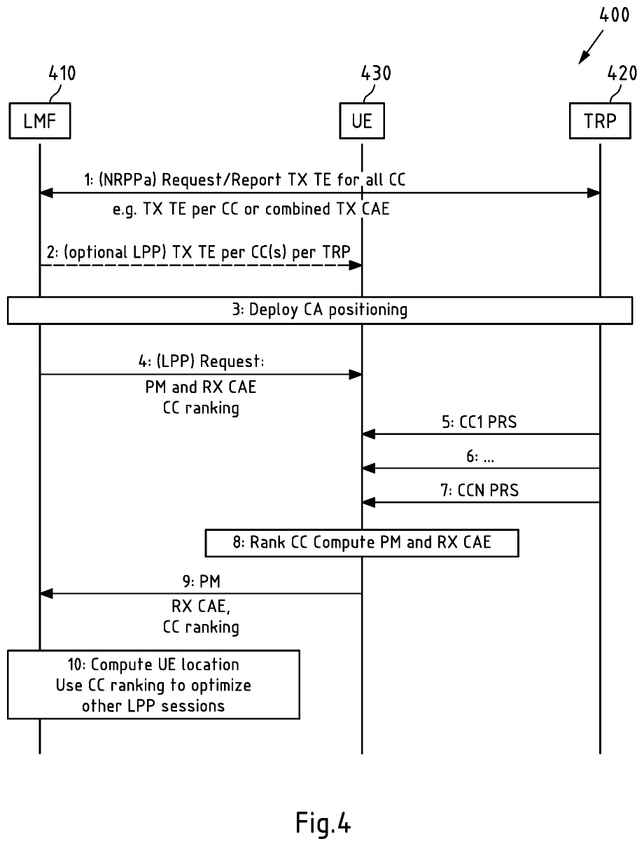

FIG. 4 a signalling diagram of a system according to an exemplary aspect;

FIG. 5 a signalling diagram of a system according to an exemplary aspect;

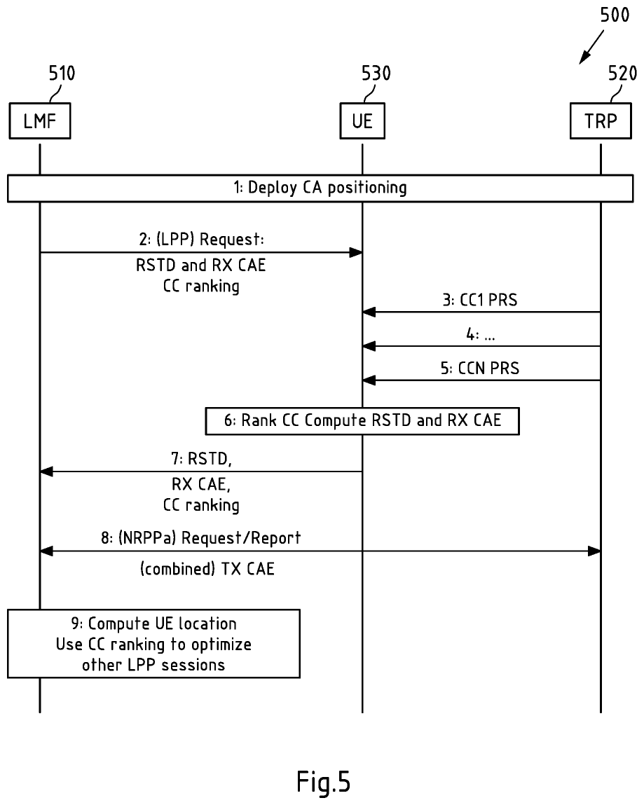

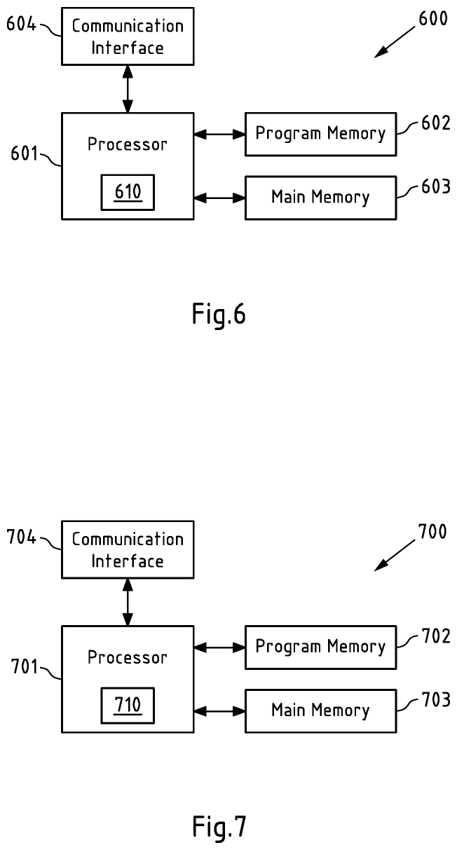

FIG. 6 a schematic block diagram of an apparatus according to the first exemplary aspect;

FIG. 7 a schematic block diagram of an apparatus according to the second exemplary aspect; and

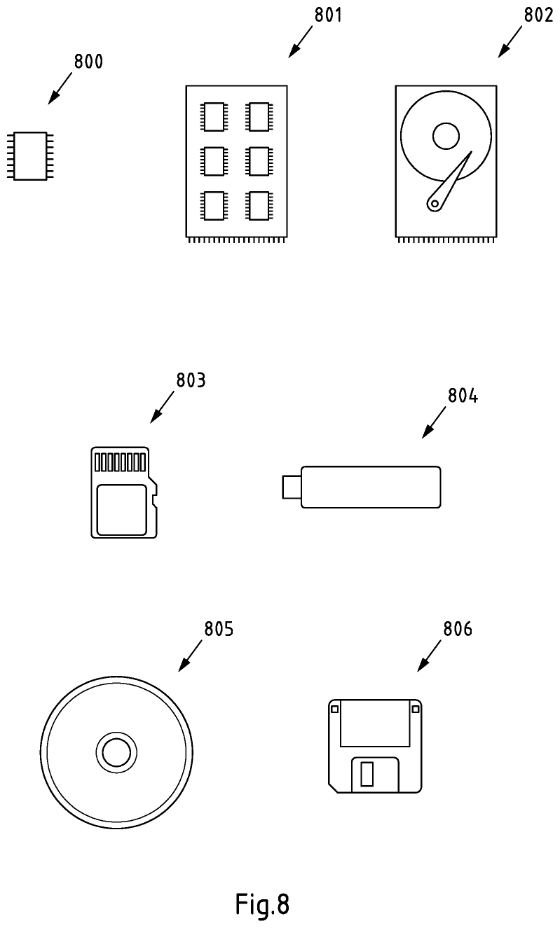

FIG. 8 examples of storage media.

### DETAILED DESCRIPTION OF SOME EXEMPLARY EMBODIMENTS

The following description serves to deepen the understanding and shall be understood to complement and be read together with the description as provided in the above summary section of this specification.

FIG. 1 is a schematic high-level block diagram of a system 100 comprising two first apparatus, e.g. a base station, here two gNBs 120-1 and 120-2 representing a respective TRP, another first apparatus, e.g. respective user device 130 and a second apparatus, the LMF 110. The entities 110, 120-1, 120-2 and/or 130 are part of or form a mobile communication network (not shown).

Via such a mobile communication network, the entities 110, 120-1, 120-2 and/or 130 can communicate with each other, as illustrated by the shown double arrows pointing between the respective entities 110, 120-1, 120-2 and/or 130.

Example embodiments of all exemplary aspects may allow enhancements of (e.g. CA) positioning based on a TEG positioning framework. This may allow e.g. the LMF 110 to cope e.g. with variable timing errors (TE) affecting different frequency parts (i.e., one or more CCs) of CA PRS(s) or of SRS(s). For simplicity, the example embodiments of all exemplary aspects are herewith presented in a DL scenario. It will be understood that the UL scenario is a straightforward alternative and extension, e.g. based on SRS(s) instead of PRS(s).

Example embodiments of all exemplary aspects may use one or more of the following as respective error values considered for determining the combined CAE:

### Tx Timing Error

From a signal transmission perspective, there will be a time delay from the time when the digital (e.g. RF) signal is generated at a baseband to the time when the RF signal is transmitted from the Tx antenna e.g. at a respective first apparatus. For supporting positioning, the first apparatus (e.g. user device, TRP) may implement an internal calibration/compensation of the Tx time delay for the transmission of the DL PRS/UL SRS signals, which may also include the calibration/compensation of the relative time delay between different RF chains in the same apparatus (e.g. first apparatus). The compensation may also possibly consider the offset of the Tx antenna phase center to the physical antenna center. However, the calibration may not be perfect. The remaining Tx time delay after the calibration, or the uncalibrated Tx time delay is defined as Tx timing error.

### Rx Timing Error

From a signal reception perspective, there will be a time delay from the time when the RF signal arrives at the Rx antenna e.g. of the first apparatus (e.g. user device, TRP) to the time when the signal is digitized and time-stamped at the baseband. For supporting positioning, the first apparatus (e.g. user device, TRP) may implement an internal calibration/compensation of the Rx time delay before the first apparatus may report the measurements that are obtained (e.g. measured) from (e.g. based on) the DL PRS/UL SRS signals, which may also include the calibration/compensation of the relative time delay between different RF chains in the same first apparatus (e.g. UE/TRP). The compensation may also possibly consider the offset of the Rx antenna phase center to the physical antenna center. However, the calibration may not be perfect. The remaining Rx time delay after the calibration, or the uncalibrated Rx time delay is defined as Rx timing error.

### UE TX ‘Timing Error Group’ (UE Tx TEG)

A UE (e.g. first apparatus such as the user device) Tx TEG is associated with the transmission of one or more UL SRS resources for the positioning purpose, which have the Tx timing errors within a certain margin.

### TRP Tx ‘timing Error Group’ (TRP Tx TEG)

A TRP (e.g. first apparatus such as a respective TRP) Tx TEG is associated with the transmissions of one or more DL PRS resources, which have the Tx timing errors within a certain margin.

### UE Rx ‘Timing Error Group’ (UE Rx TEG):

A UE (e.g. first apparatus such as the user device) Rx TEG is associated with one or more DL measurements, which have the Rx timing errors within a certain margin.

### TRP Rx ‘Timing Error Group’ (TRP Rx TEG):

A TRP (e.g. first apparatus such as a respective TRP) Rx TEG is associated with one or more UL measurements, which have the Rx timing errors within a margin.

### UE RxTx ‘Timing Error Group’ (UE RxTx TEG)

A UE (e.g. first apparatus such as the user device) RxTx TEG is associated with one or more UE Rx-Tx time difference measurements, and one or more UL SRS resources for the positioning purpose, which have the ‘Rx timing errors+Tx timing errors’ within a certain margin.

### TRP Rxtx ‘Timing Error Group’ (TRP Rxtx TEG)

A TRP (e.g. first apparatus such as a respective TRP) RxTx TEG is associated with one or more gNB Rx-Tx time difference measurements and one or more DL PRS resources, which may have the ‘Rx timing errors+Tx timing errors’ within a certain margin.

Example embodiments of all exemplary aspects may thus allow to mitigate positioning errors associated with a respective transmit and/or receive processing chain as follows: NR defines a framework for reporting TEG which are, in essence timing error margins and may be indicated to a LMF 110 from a user device 130. Such timing error margins may indicate what is the range within which the timing measurements can vary. For example, the respective user device 130 may report (e.g. per antenna panel, and/or per PRS resource), a TEG of +/−30 ns, which means that the respective user device's 130 transmit chain used for that particular PRS resource may introduce an error with a value anywhere in the interval [−30, 30] ns. Further, Tx/Rx timing errors may appear due to e.g.:
sampling time offset (STO) between the clock rates of the transmitter and receiver of a given signal;
carrier frequency offset (CFO) between the carrier frequencies of the transmitter and receiver of a given signal; and/or
phase noise (PN),
   where STO, CFO, PN themselves may further be sensitive to temperature, bandwidth, carrier, or a combination thereof, to name but a few non-limiting examples.

A respective LMF 110 may have to deal with the measurements labelled with such various TEG when determining (e.g. computing or estimating) a target position of the respective user device 130. If enough measurements are collected, then the LMF may decide to use the measurements in a weighted manner, where the weights are inversely proportional to the TEG level.

However, such an approach may not remove timing errors, but (e.g. only) give an indication of how accurate the final position determined (e.g. position estimation) is expected to be. In other words, such a TEG framework defines procedures through which the errors ranges are identified. However, it would be beneficial to have means for cancelling the Tx/Rx errors associated with a positioning signal transmission and/or reception.

Further, the TEG framework (e.g. a RAN1 TEG framework) may enable that a respective TEG reporting may be used to create further differential measurements (e.g. combine RSTD measurements that have the same Rx TEG). This type of grouping and further differencing is possible to remove effects of such timing errors. However, this requires a sufficient amount of measurements that need to be available for the same TEGs. It would be beneficial to allow for a combining of measurements across multiple TRPs if those TRPs have different Tx TEGs (e.g. as is typical) for DL measurements (e.g. of PRS(s)) or Rx TEGs for UL measurements (e.g. of SRS(s)).

CA positioning may complex such situations, since e.g. aggregated CCs may suffer to a different degree from STO, CFO and PN, since a respective transmission is realized over a different RF chain of the respective first and/or second apparatuses, and/or respective one or more offsets that may be carrier dependent. Specifically, when a respective PRS transmission is spread over different carriers, different parts of such a signal may be affected by different offsets, and therefore, introduce different timing errors. Therefore, example embodiments of all exemplary aspects allow to:
1. To determine a combined CAE (e.g. to derive a TEG per PRS resource) so that such a combined CAE may characterize (e.g. sufficiently well) one or more errors over a respective aggregated carrier of one or more CCs (i.e., a single TEG does hold over all carriers and/or there are independent TEGs for a respective carrier); and
2. To enable to determine a respective position by a respective LMF 110, wherein a respective TEG may still be useful for the LMF 110 given that:
   different parts of the same signal are characterized by different errors, and/or
   a respective signal may be used in its entirety by the respective user device 130 to determine (e.g. compute) a single positioning metric (e.g. combined CAE).

Therefore, example embodiments of all exemplary aspects may form a framework for obtaining a combined CAE (e.g. indicating or representing or comprising an error value) e.g. representative of a (e.g. CA) PRS and/or SRS Tx/Rx timing error.

Example embodiments of all exemplary aspects thus enable that
A. the first apparatus (e.g. user device 130) obtaining and using TRPs information about TX TE per CC or, when available, of a combined/aggregated TE (e.g. information acquisition intermediated by the LMF 110).
B. The first apparatus (e.g. user device 130) determining (e.g. computing and e.g. signaling) upon request of the second apparatus (e.g. LMF 110):
   a. a total carrier aggregation error (e.g. combined CAE) which is the result of the TX/Rx RF errors but also of the PRS baseband processing (e.g., how the CC(s) is (are) combined by the user device 130); and/or
   b. a CC ranking which is indicative of how/if the CC(s) was (were) used.

The signalling exchange may allow to:
a) determine (e.g. derive) CAE by the first apparatus (e.g. user device 130),
b) determine (e.g. derive) a ranking of the various CC by the first apparatus (e.g. user device 130),
c) obtain a) and b) by the second apparatus (e.g. LMF 110) so that the positioning metric utilization may be optimized.

Specifically, to perform a) and b), the first apparatus (e.g. user device 130) may obtain information on 1) from the second apparatus (e.g. LMF 110), either as:
a list of error margins {txe1, . . . , txeN}, or
when available, a combined Tx error margin, characterizing the CA signal (e.g. also referred to as (e.g. combined) Tx-CAE),
a list of differential TEs (error difference between different TEGs across TEGs where each TEG is associated with a CC).
   it might be helpful for UE-based positioning (e.g. positioning performed and/or controlled by the first apparatus): For example, in case that differential TE of (TRP Tx TEG #1(CC #1), TEG #2 (CC #2)) is far less than (TRP Tx TEG #1(CC #1), TEG #3(CC #3)), the first apparatus (e.g. user device 130) would rather perform Reference Signal (RS) measurements based on CC #1 and CC #2 than perform measurements from CC #1 and CC #3.

Similarly to do c), the second apparatus (e.g. LMF 110) may receive from the first apparatus (e.g. user device 130):
CAE (e.g. combined CAE) as a point value or as an interval; and/or
information about how the first apparatus (e.g. user device 130) has used/combined the CC, e.g. a CC ranking.

FIG. 2 is a flowchart 200 showing an example embodiment of a method according to the first exemplary aspect. This flowchart 200 may for instance be performed by a first apparatus, e.g. user device 130 of FIG. 1, or a respective TRP that may be enabled by a respective base station 120-1 or 120-2 of FIG. 1. In the latter case, the first apparatus represents a respective TRP.

In a first step 201, a request for measuring at least a combined carrier aggregation error, CAE of one or more component carriers, CCs, configured for the first apparatus in a mobile communication network is obtained, e.g. by receiving the request from a second apparatus (e.g. LMF of FIG. 1).

In a second step 202, based on the request, at least one of one or more positioning reference signals, PRSs, or one or more sounding reference signals, SRSs, of the one or more CCs are obtained, e.g. by measuring the respective one or more PRSs and/or the respective one or more SRSs of the one or more CCs.

In a third step 203, based, at least in part, on at least one of the obtained one or more PRSs, or the one or more SRSs, the combined CAE is determined. The combined CAE is indicative of total combined CAE resulting from at least one of a transmit error, receive error, or a processing of the one or more CCs. The combined CAE may comprise or represent a point value, an interval or a range, to name but a few non-limiting examples. Based on the obtained one or more PRSs and/or the one or more SRSs, the combined CAE may be determined, e.g. based at least in part on a result of one or more Tx/Rx RF errors, but also of the PRS (DL scenario) respective SRS (UL scenario) baseband processing of the first apparatus. In this way, the determined combined CAE comprises, represents or is indicative of a total carrier aggregation error resulting from one or more Tx/Rx RF errors and the baseband processing.

In a fourth step, the determined combined CAE is provided, e.g. by sending the combined CAE e.g. to the second apparatus. The determined combined CAE may be provided to the respective entity from which the first apparatus may have obtained the request in step 201.

FIG. 3 is a flowchart 300 showing an example embodiment of a method according to the second exemplary aspect. This flowchart 300 may for instance be performed by a second apparatus, e.g. LMF 110 of FIG. 1.

The flowcharts 200 of FIG. 2 and the flowchart 300 may be performed and/or controlled jointly, e.g. by a system 100 of FIGS. 1, 400 of FIGS. 4 and/or 500 of FIG. 5.

In a first step 301, a request for measuring at least a carrier aggregation error, CAE of one or more component carriers, CCs configured for a first apparatus (e.g. user device 130 of FIG. 1) or a TRP (TRPs enabled by gNBs 120-1 and/or 120-2 of FIG. 1) in a mobile communication network is sent, e.g. by providing the request so that the respective receiving entity can obtain the request (see also step 201 of FIG. 1).

In a second step 302, the combined CAE is obtained, e.g. by receiving the combined CAE, e.g. from a respective entity to which the request was sent in step 301.

In a third step 303, a position of the first apparatus (e.g. at least one of a user device 130 of FIG. 1 or TRP 120-1 and/or 120-2 of FIG. 1) is determined, based, at least in part on the obtained combined CAE of step 302. Optionally, the determined position may be sent (e.g. provided) to another entity of the mobile communication network, e.g. the first apparatus.

FIG. 4 is a signalling diagram of a system 400 according to an exemplary aspect. System 400 comprises a first apparatus, here a user device 430 (labelled as UE in FIG. 4), a respective TRP 420, and a LMF 410.

The signalling diagram of FIG. 4 may enable an information exchange, by the procedure as depicted in FIG. 4.

In an example embodiment of all exemplary aspects, one or more of the following details, the one or more functionalities of one or more various components are also considered to be disclosed.

In step (e.g. signal) 1, the LMF 410 requests and receives the TX error margin(s) for the indicated carriers via a new IE in the NRPPa assistance data and respectively capability report. The report may contain either the TE per CC, a combined TE for all CCs, or a differential TE, the latter identifying which CCs have similar Tx TE.

In step (e.g. signal) 2, the LMF 410 may optionally attach the Tx error margins to the LPP assistance data (e.g. as a new IE).

In step (e.g. block) 3, CA positioning is deployed between them LMF 410, the UE 430 and a respective TRP 420.

In step (e.g. signal) 4, the LMF 410 requests the UE 430 to measure one/more PMs and the combined CAE stemming from aggregating the indicated CCs. The LMF 410 may additionally request a CC ranking, which is indicative of how the CCs where combined at the UE 430 e.g.:
if (e.g. all) CCs have been used with equal weight or different weight,
if (e.g. all) CCs have been discarded e.g. by assigning them a “0” weight/rank. For example, if the UE reports a CC ranking {CC1-rank=2, CC2-rank=2, CC3-rank=1, CC4-rank=0}, this indicates that CC1 and CC2 have the highest weight, i.e. w)2/(2+2+1+0), in the PM estimation, followed by CC3, while CC4 was discarded.

In steps (e.g. signals 5 to 7) the UE 430 obtains one or more PRSs, e.g. by measuring the respective PRS of the respective CCs configured for the UE 430, based, at least in part, on the respective PRSs of the respective CCs as provided by the TRP 420. As indicated by the numbering CC1, CC2, . . . , CCN, a plurality of different CC PRSs may be obtained (e.g. measured) by the UE 430.

In step (e.g. block) 8, the UE 430 obtains (e.g. receives) N CC PRS (see steps (e.g. signals) 5-7), e.g. on a different carrier and potentially with different bandwidths. After the UE 430 samples each CC of the one or more CCs with the respective sampling rate, the UE 430 combines the carriers according to its own capabilities. For example, the UE 430 may sample a respective (e.g. each) carrier “N” with the corresponding resolution 1/bN and optionally:
1. use advanced processing method to make the superimposed signal look like having a fine sampling resolution equivalent to 1/b. The resulting signal is then used to retrieve one PM e.g. TOA, with the same very fine resolution. Or, conversely,
2. obtain one PM per carrier “N”, at a resolution 1/bN, and then combine said metrics ((e.g. each) of the obtained CC PRSs with different resolution) over all/some carriers, to determine (e.g. compute) and provide (e.g. report) an average, e.g. as a respective combined CAE, here referred to as RX CAE in step (e.g. signal) 9. Optionally, in step (e.g. signal) 9, a CC ranking, if determined, is provided by the UE 430 to the LMF 410.

In step (e.g. signal) 9, e.g. via new IE in the LPP measurement report, the UE 430 may thus transfer the combined CAE and/or the CC ranking.
in another embodiment, the UE 430 may report the combined CAE and/or the CC ranking information independent with the measurements. For the fixed ranking information, the UE 430 may report PM multiple times.

Methods/procedures 1 and 2 (or variations thereof) may be associated with an overall estimation error, due to:
a. the accuracy of post processing i.e., how the samples are obtained and used by example embodiments of all exemplary aspects;
b. the CC specific Tx and Rx TE; and/or
c. how the different CC are combined and/or excluded from combination.

With regard to c., the UE 430 may assess the quality of the signal at a respective (e.g. each) CC, and rank the respective CCs by their cleanliness, e.g. ranking which is then used to combine the signal samples for the joint PM, combined CAE determining (e.g. estimation).

In a step (e.g. block) 10, the LMF 410 that obtains (e.g. receives) may then consume the UE's 430 report and determine (e.g. compute or estimate) a respective position of the UE 430. The LMF 410 may subsequently use the CC ranking to optimize the design of a future LPP session for the same UE 430, or for a nearby neighbor.

As one illustrative example of all exemplary aspects, it is assumed that the UE 430 is combining two CCs for a positioning measurement.

A respective UE (e.g. first apparatus) receives a request for measuring at least a combined CAE, wherein the request may be from or stemming from the LMF.

The UE measures (e.g. obtains) a reference signal RS1 (e.g. a first PRS) on CC1 (e.g. a first CC of one or more CCs configured for the apparatus in a mobile communication system) and another reference signal RS2 (e.g. a second PRS) on CC2 (e.g. a second CC of the one or more CCs).

For determining the combined CAE, the UE may combine measurements according to a CC ranking (i.e. the UE may weight (e.g. determine weights/CC ranks) the respective measurements RS1 and RS2), e.g. to obtain combined position measurement.

Further, the UE may determines Rx/Tx error of the RS1 measurement and Rx/Tx error of the RS2 measurement.

The UE determines the combined CAE based on the combined position measurement e.g. by summing the Rx/Tx errors of RS1 and RS2 according to respective weighting in the combined position measurement (i.e. Rx/Tx error of RS1* weight of RS1 in combined position measurement result+Rx/Tx error of RS2 * weight in combined position measurement result).

Finally, the UE sends (e.g. provided) the combined CAE, e.g. to the LMF.

Regarding a respectively determined CC ranking, the following is mentioned for exemplary purpose: CC_A has a TEG margin of +/−4 ns and CC_B has a TEG margin of +/−2 ns. If the UE 430 determines it should weight CC_A with a value of 0.25 and CC_B with a value of 0.75 then the UE 430 may estimate that the combined TEG margin has a value of +/−2.5 ns (0.25*4 ns+0.75*2 ns).

FIG. 5 shows a signalling diagram of a system 500 according to an exemplary aspect. System 500 comprises a first apparatus, here a user device 530 (labelled as UE in FIG. 5), a respective TRP 520, and a LMF 510.

The signalling diagram of FIG. 5 may be similar to the signalling diagram of FIG. 4 e.g. starting from the block ‘Deploy CA positioning’, and may thus enable a similar information exchange as shown by the procedure of FIG. 4. However, in FIG. 5, instead of PM, RSTD is utilized, at least in part. Thus, e.g. in step (e.g. signal 2), a respective (LPP) request from the LMF 530 is for RSTD and combined RX CAE, and optionally a respective CC ranking, instead of PM and combined RX CAE, and optionally a respective CC ranking.

Example embodiments of all exemplary aspects, and e.g. as illustrated in FIG. 5, may allow a scheme for which PM is equal to (=) RSTD and/or for which the respective TRPs (e.g. as provided by gNBs 120-1, 120-2 of FIG. 1) may provide (e.g. report) a combined Tx CAE. Details are disclosed in the following based on FIG. 5:

For instance, a scenario may be assumed with two TRPs, where:
TRP1 transmits PRS1 on CC1 and CC2 and
TRP2 transmits PRS2 on CC1 and CC2.

For reasons of simplicity, in FIG. 5, only a single instance of a respective TRP 520 is shown.

The UE 530 may be instructed to measure RSTD between TRP1 and TRP2 from the LMF 510, and to provide (e.g. report) a combined Rx CAE. Subsequent to the CA PRS reception on the multiple or plurality of CCs, the UE 530 performs and/or controls the respective (CA) RSTD measurement across CC1 and CC2, in the case of above introduced scenario. Next, the UE 530 reports a single (RSTD, CAE) pair and CC ranking, implicitly indicating whether the UE 530 has combined the respective CCs (or which CCs of the one or more CCs configured for the first apparatus) or not. For instance, and in general, a/the respective CC ranking may indicate which CCs of the one or more CCs have been combined. Then, a single CAE (e.g. value) may indicate a respective error (e.g. a transmit error, receive error, and/or a processing (e.g. error or delay) of the one or more CCs) due to combining the respectively CCs as comprised by the CC ranking.

Upon reception of the combined Rx CAE by the LMF 510 (see step (e.g. signal 7), the LMF 510 assesses how the CCs have been combined. The LMF 510 may request e.g. from each TRP 520 a Tx CAE, i.e. the combined Tx TE, where the combination is done for the respective CC which were used by the UE 530.

When the TRP 520 sends (e.g. reports) Tx CAE, there may be at least two options:
in option 1, the TRP 520 simply reports the TX TEG of each individual CC and the LMF 510 may then assume the overall Tx CAE margin, e.g. as a summation of the individual Tx TEG (i.e., CC1 Tx TEG margin+CC2 Tx TEG margin).
in option 2, the TRP 520 reports a combined Tx CAE directly which may take into account any optimizations the TRP 520 can do or has characterized based on a respective CA transmission (e.g., if the CCs share some components, the overall CAE margin may be strictly smaller than the combined TEG margins).

Each TRP of the two TRPs, TRP1 and TRP2 in the case of the described scenario, reports a respective Tx CAE (e.g. Tx CAE1 and Tx CAE2) (or (a) respective component(s) necessary for the LMF 510 to determine (e.g. calculate) the respective Tx CAE1 and Tx CAE2). Next, the LMF 510 stores the obtained (e.g. received) report(s) comprising e.g. RSTD, CAE, Tx CAE1, Tx CAE2 (e.g. between steps/signals 7 and 9). The LMF 510 may be able to consider this for further differential operation between RSTD measurements tagged with the same Tx/Rx CAE information (see step (e.g. signal) 8). In addition, the LMF 510 may provide the UE 530 with these information for UE-based positioning (after step (e.g. block) 9), similar to the disclosure above regarding step (e.g. block) 10 of FIG. 4.

As already disclosed, but mentioned again for the reason of completeness, this approach can be straightforwardly extended to a respective UL case. For instance, this may be done by replacing PRS with SRS, and interchanging the UE and TRP roles:
DL case: user device obtains one or more PRSs from one or more TRPs;
UL case: TRP obtains one or more SRSs from one or more user devices.

FIG. 6 shows a schematic block diagram or a functional block of a first apparatus 600 (e.g. user device 130 of FIG. 1, and/or TRP enabled by a respective base station (e.g. gNB) 120-1 and/or 120-2 of FIG. 1) according to at least some exemplary aspects. The first apparatus 600 comprises a communication interface 604. The communication interface 604 may in particular comprise at least one antenna. Additionally or alternatively, the communication interface 604 may correspond to a virtual communication means that allows exchange of information with other entities of the communication network e.g. of the system 100 of FIG. 1. The first apparatus 600 further comprises at least one main memory 603 and/or at least one program memory 602. The instructions of an exemplary aspect may be stored on the main memory 603 and/or the program memory 462. The first apparatus 600 may further comprise at least one processor 601.

The first apparatus 600 may further comprise at least one combined CAE determiner 610. The combined CAE determiner 610 may be configured to determine a combined CAE based on a request obtained from e.g. an apparatus of the second exemplary aspect.

The first apparatus 600 may comprise a transceiver. The transceiver may be configured to transmit and/or receive a request or a positioning request to and/or from a second apparatus (e.g. LMF 110 of FIG. 1) and/or to and/or from a respective TRP (e.g. enabled by a respective base station (e.g. gNB) 120-1 and/or 120-2 of FIG. 1) in case apparatus 600 represents a user device (e.g. user device 130 of FIG. 1), or to and/or from a respective user device in case apparatus represents a respective TRP (e.g. TRP 120-1 or 120-2 of FIG. 1).

FIG. 7 shows a schematic block diagram or a functional block of a first apparatus 700 (e.g. LMF 110 of FIG. 1) according to at least some exemplary aspect. The second apparatus 700 comprises a communication interface 704. The communication interface 704 may comprise at least one antenna. Additionally or alternatively, the communication interface 704 may correspond to a virtual communication means that allows exchange of information with other entities of the communication network e.g. of the system 100 of FIG. 1. The second apparatus 700 further comprises at least one main memory 703 and/or at least one program memory 702. The instructions of an exemplary aspect may be stored on the main memory 703 and/or the program memory 702. The second apparatus 700 may further comprise at least one processor 701.

The second apparatus 700 may further comprise at least one position determiner 710. The position determiner 710 may be configured to determine a position of a user device and/or of a TRP (e.g. respective apparatuses of the first exemplary aspect).

The second apparatus 700 may comprise a transceiver. The transceiver may be configured to transmit and/or receive a request or a positioning request to and/or from a first apparatus (e.g. user device 130 of FIG. 1) and/or to and/or from a respective TRP (e.g. enabled by a respective base station (e.g. gNB) 120-1 and/or 120-2 of FIG. 1).

The program and/or main memory 602, 603, and/or 702, 703 of the corresponding apparatuses 600 and/or 700 may comprise random-access memory (RAM) and/or read-only memory (ROM). The program and/or main memory 602, 603, and/or 702, 703 may comprise at least one RAM chip, and/or at least one ROM chip, and/or at least one flash memory chip. The program and/or main memory 602, 603, and/or 702, 703 may comprise solid-state, magnetic, and/or optical memory, for example. The program and/or main memory 602, 603, and/or 702, 703 may be at least in part accessible to the corresponding at least one processor 601 or 701, The program and/or main memory 602, 603, and/or 702, 703 may be at least in part comprised in the corresponding at least one processor 601 or 701. The program and/or main memory 602, 603, and/or 702, 703 may be at least in part external to the corresponding apparatus 600 or 700. The program and/or main memory 602, 603, and/or 702, 703 may comprise instructions that the corresponding at least one processor 601 or 701 is configured to execute. Instructions for performing certain actions may be stored in the program and/or main memory 602, 603, and/or 702, 703 to cause, with the corresponding at least one processor 601 or 701, the corresponding apparatus 600 or 700 to perform these actions.

FIG. 8 is a schematic illustration of examples of tangible and/or non-transitory computer-readable storage media comprising instructions for performing actions according to example embodiments of the present invention, such as a flash memory 800, which may for instance be soldered or bonded to a printed circuit board, a solid-state drive (SSD) 801 comprising a plurality of memory chips (e.g. Flash memory chips), a magnetic hard drive 802, a Secure Digital (SD) card 803, a Universal Serial Bus (USB) memory stick 804, an optical storage medium 805 (such as for instance a CD-ROM or DVD) and a magnetic storage medium 806.

The following embodiments shall also be considered to be disclosed:

### Embodiment 1

A method, e.g. performed by a user device or a TRP, the method comprising: obtaining a request for measuring at least a combined carrier aggregation error, CAE of one or more component carriers, CCs, configured for the apparatus in a mobile communication network, wherein the combined CAE is indicative of a total of one or more errors resulting from at least one of a transmit error, receive error, or a processing of the one or more CCs; obtaining, based on the request, at least one of one or more positioning reference signals, PRSs, or one or more sounding reference signals, SRSs, of the one or more CCs;

determining, based, at least in part, on at least one of the obtained one or more PRSs, or the one or more SRSs, the combined CAE; and providing the determined combined CAE.

### Embodiment 2

The method according to embodiment 1, wherein the combined CAE is a measure of error associated with a received signal time difference, RSTD, measurement over multiple CCs.

### Embodiment 3

The method according to embodiment 1 or embodiment 2, wherein the request is indicative of at least the one or more CCs.

### Embodiment 4

The method according to any of the preceding embodiments, wherein the request is further for a CC ranking, wherein the apparatus further comprises:
determining the CC ranking indicative of a weighting of the one or more CCs, wherein the CC ranking is determined based on at least one of the obtained one or more PRSs or SRSs.

### Embodiment 5

The method according to embodiment 4, wherein the combined CAE is determined based on the CC ranking and at least one of the transmit error or receive error of respective CCs.

### Embodiment 6

The method according to any of the preceding embodiments, wherein the request is comprised by or is accompanying LPP assistance data.

### Embodiment 7

The method according to any of the preceding embodiments, wherein the request is further for measuring at least one of one or more positioning measurements, PMs, or one or more received signal time differences, RSTDs, wherein the method further comprises:
determining at least one of the one or more PMs or the one or more RSTDs based, at least in part, on a respective PM for a certain CC of the one or more CCs for which at least one of the one or more PRSs or SRSs are obtained, or on a respective RSTD of a certain CC of the one or more CCs for which at least one of the one or more PRSs or SRSs are obtained.

### Embodiment 8

The method of embodiment 7, wherein a respective PM of the one or more PMs is represented by a timing measurement.

### Embodiment 9

The method according to any of the embodiments 7 to 8, wherein the combined CAE is determined, based on the weighting of a respective CC of the one or more CCs and the one or more PMs or RSTDs.

### Embodiment 10

A method, performed by a LMF, the method comprising:
sending a request for measuring at least a combined carrier aggregation error, CAE of one or more component carriers, CCs configured for a user device or a transmission and reception point, TRP, in a mobile communication network, wherein the combined CAE is indicative of a total of one or more errors resulting from at least one of a transmit error, receive error, or a processing of the one or more CCs;
obtaining the combined CAE; and
determining a position of at least one of the user device or TRP based, at least in part, on the obtained combined CAE.

### Embodiment 11

The method according to embodiment 10, further comprising:
providing a positioning request comprising at least one of a transmit, Tx, timing error per CC of the one or more CCs, or a combined Tx CAE.

### Embodiment 12

The method according to embodiment 10 or embodiment 11, further comprising:
obtaining a positioning report indicative of at least one of the Tx timing error per CC of the one or more CCs or the combined Tx CAE.

### Embodiment 13

The method according to any of the embodiments 10 to 12, further comprising:
providing at least one of the Tx timing error or the combined Tx CAE to at least one of the user device or the TRP.

### Embodiment 14

The method according to any of the embodiments 10 to 13, wherein the request is indicative of the one or more CCs.

### Embodiment 15

The method according to any of the embodiments 10 to 14, wherein the request is further for a CC ranking, wherein the method further comprises:
obtaining the CC ranking indicative of a weighting of the one or more CCs.

Embodiment 16

The method according to any of the embodiments 10 to 15, wherein the request is comprised by or is accompanying LPP assistance data.

### Embodiment 17

The method according to any of the embodiments 10 to 16, wherein the request is further for measuring at least one of one or more positioning measurements, PMs, or one or more received signal time differences, RSTDs, wherein the method further comprises:
obtaining the one or more PMs or the one or more RSTDs.

### Embodiment 18

The method according to any of the embodiments 15 to 17, further comprising:
determining one or more parameters for one or more LPP sessions served by the apparatus based, at least in part, on the obtained CC ranking.

### Embodiment 19

A first apparatus comprising respective means for performing the method of any of embodiments 1 to 9.

### Embodiment 20

A first apparatus comprising at least one processor and at least one memory storing instructions that, when executed by the at least one processor, cause an apparatus at least to perform and/or control the method according any of embodiments 1 to 9.

### Embodiment 21

A second apparatus comprising respective means for performing the method of any of embodiments 10 to 18.

### Embodiment 22

A second apparatus comprising at least one processor and at least one memory storing instructions that, when executed by the at least one processor, cause an apparatus at least to perform and/or control the method according any of embodiments 10 to 18.

### Embodiment 23

A computer program, the computer program when executed by a processor causing an apparatus, e.g. the apparatus according to any of embodiments 19 to 22, to perform and/or control the actions and/or steps of the method of any of embodiments 1 to 18.

### Embodiment 24

A computer program product comprising a computer program according to embodiment 23.

### Embodiment 25

A system comprising:
at least one first apparatus according to any of the embodiments 19 or 20; and
at least one second apparatus according to any of the embodiments 21 or 22.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Having the same meaning as the expression “A and/or B”, the expression “at least one of A or B” may be used herein. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1-24. (canceled)

25. An apparatus comprising:
a processor; and
a memory comprising computer-executable instructions that, when executed by the processor, cause the apparatus to perform the following operations:
obtaining a request for the following: a component carrier (CC) ranking, measuring positioning measurements (PMs) and one or more received signal time differences (RSTDs), and for measuring a combined carrier aggregation error (CAE) of CCs configured for the apparatus in a mobile communication network, wherein the combined CAE is indicative of a total of errors resulting from a transmit error, receive error, and a processing of the CCs;
obtaining, based on the request, one or more positioning reference signals (PRS) and one or more sounding reference signals (SRSs) of the one or more CCs;
determining the PMs or the one or more RSTDs based on a respective PM for a certain CC of the CCs for which at least the PRSs and the SRSs are obtained, or on a respective RSTD of a certain CC of the CCs for which at least the PRSs and the SRSs are obtained;
determining the CC ranking indicative of a weighting of the CCs based on the PRSs and the SRSs;
determining the combined CAE based on the following: the PRSs and the SRSs; the CC ranking, the transmit error, and the receive error of respective CCs; and on the weighting of a respective CC of the CCs and the PMs or RSTDs; and
providing the determined combined CAE to a second apparatus for determining a position of the apparatus based on the combined CAE, the second apparatus being a location management function (LMF) of a base station.

26. The apparatus according to claim 25, wherein the request is indicative of the CCs.

27. The apparatus according to claim 26, wherein the request is comprised by or is accompanying long term evolution (LTE) positioning protocol (LPP) assistance data.

28. The apparatus according to claim 27, wherein a respective PM of the PMs is represented by a timing measurement.

29. The apparatus according to claim 28, wherein the apparatus is a user device.

30. The apparatus according to claim 29, wherein the CC ranking is indicative of how the CCs where combined based on if all the CCs have been used with equal weight or different weight.

31. The apparatus according to claim 29, wherein the CC ranking is indicative of how the CCs where combined based on if all the CCs have been discarded.

32. A system comprising:
an apparatus;
a processor; and
a memory comprising computer-executable instructions that, when executed by the processor, cause the apparatus to perform the following operations:
obtaining a request for the following: a component carrier (CC) ranking, measuring positioning measurements (PMs) and one or more received signal time differences (RSTDs), and for measuring a combined carrier aggregation error (CAE) of CCs configured for the apparatus in a mobile communication network, wherein the combined CAE is indicative of a total of errors resulting from a transmit error, receive error, and a processing of the CCs;
obtaining, based on the request, one or more positioning reference signals (PRS) and one or more sounding reference signals (SRSs) of the one or more CCs;
determining the PMs or the one or more RSTDs based on a respective PM for a certain CC of the CCs for which at least the PRSs and the SRSs are obtained, or on a respective RSTD of a certain CC of the CCs for which at least the PRSs and the SRSs are obtained;
determining the CC ranking indicative of a weighting of the CCs based on the PRSs and the SRSs;
determining the combined CAE based on the following: the PRSs and the SRSs; the CC ranking, the transmit error, and the receive error of respective CCs; and on the weighting of a respective CC of the CCs and the PMs or RSTDs; and
providing the determined combined CAE to a second apparatus for determining a position of the apparatus based on the combined CAE, the second apparatus being a location management function (LMF) of a base station.

33. The system according to claim 32, wherein the request is indicative of the CCs.

34. The system according to claim 33, wherein the request is comprised by or is accompanying long term evolution (LTE) positioning protocol (LPP) assistance data.

35. The system according to claim 34, wherein a respective PM of the PMs is represented by a timing measurement.

36. The system according to claim 35, wherein the apparatus is a user device.

37. The system according to claim 36, wherein the CC ranking is indicative of how the CCs where combined based on if all the CCs have been used with equal weight or different weight.

38. The system according to claim 37, wherein the CC ranking is indicative of how the CCs where combined based on if all the CCs have been discarded.

39. A method comprising:
obtaining, by a user equipment (UE), a request for the following: a component carrier (CC) ranking, measuring positioning measurements (PMs) and one or more received signal time differences (RSTDs), and for measuring a combined carrier aggregation error (CAE) of CCs configured for the apparatus in a mobile communication network, wherein the combined CAE is indicative of a total of errors resulting from a transmit error, receive error, and a processing of the CCs;
obtaining, by the UE based on the request, one or more positioning reference signals (PRS) and one or more sounding reference signals (SRSs) of the one or more CCs;
determining, by the UE, the PMs or the one or more RSTDs based on a respective PM for a certain CC of the CCs for which at least the PRSs and the SRSs are obtained, or on a respective RSTD of a certain CC of the CCs for which at least the PRSs and the SRSs are obtained;
determining, by the UE, the CC ranking indicative of a weighting of the CCs based on the PRSs and the SRSs;
determining, by the UE, the combined CAE based on the following: the PRSs and the SRSs; the CC ranking, the transmit error, and the receive error of respective CCs; and on the weighting of a respective CC of the CCs and the PMs or RSTDs; and
providing, by the UE, the determined combined CAE to a second apparatus for determining a position of the apparatus based on the combined CAE, the second apparatus being a location management function (LMF) of a base station.

40. The method according to claim 39, wherein the request is indicative of the CCs.

41. The method according to claim 40, wherein the request is comprised by or is accompanying long term evolution (LTE) positioning protocol (LPP) assistance data.

42. The method according to claim 41, wherein a respective PM of the PMs is represented by a timing measurement.

43. The method according to claim 42, wherein the CC ranking is indicative of how the CCs where combined based on: if all the CCs have been used with equal weight or different weight.

44. The method according to claim 43, wherein the CC ranking is indicative of how the CCs where combined based on if all the CCs have been discarded.
